(19) United States
(12) Patent Application Publication
(10) Pub. No.: US 2025/0196171 A1
(43) Pub. Date: Jun. 19, 2025

(54) PREFILL VALVE STRUCTURE FOR REFILLABLE SPRAY BOTTLE

(71) Applicant: Canhui CHEN, Fujian (CN)

(72) Inventor: Canhui CHEN, Fujian (CN)

(21) Appl. No.: 19/063,322

(22) Filed: Feb. 26, 2025

Related U.S. Application Data
(63) Continuation-in-part of application No. PCT/CN2024/101906, filed on Jun. 27, 2024.

(30) Foreign Application Priority Data
Jun. 28, 2023 (CN) 202321663241.5

(51) Int. Cl. B05B 11/00; A45D 34/02

(52) U.S. Cl. CPC B05B 11/0056; A45D 34/02; A45D 2200/057

(57) ABSTRACT

A prefill valve structure for a refillable spray bottle, having a bottle body and a spray nozzle assembly arranged on the bottle body, wherein a partition is arranged at a lower end of the inside of the bottle body and used for dividing the bottle body into an upper cavity and a lower cavity, the center of the partition is cut through to allow liquid to flow into the bottle body. A tail valve assembly is arranged in the lower cavity of the bottle body, the tail valve assembly has a tail cover and a piston, the piston is arranged in the tail cover and provided with a filling hole and a vertically through exhaust hole, and a filling port and an exhaust plunger which correspond to the filling hole and the exhaust hole in the piston are arranged on the tail cover.

### TECHNICAL FIELD

The invention relates to the technical field of spray bottles, in particular to a prefill valve structure for a refillable spray bottle.

### DESCRIPTION OF RELATED ART

Most people in society will wear perfume before going out or going on a date to improve personal charisma. Perfume in a perfume bottle will be used up after long-term use, and a new perfume set needs to be purchased, or the perfume bottle running out of perfume needs to be prefilled to be used again.

Most perfume bottles on the present market are filled with perfume from the top, and only a few of perfume bottles can be filled with perfume from the bottom. However, when a perfume bottle is filled with perfume from the bottom, the perfume bottle should have good sealing performance to ensure that the perfume will not leak during and after filling, and air in the perform bottle can be discharged in time during filling to ensure smooth filling of the perfume.

However, perfume bottles that can be filled with perfume from the bottom on the market have an extremely complex prefill structure and exhaust structure, thus being inconvenient to produce and assemble, low in reliability, and high in production cost.

Therefore, it is necessary to figure out a new technical solution to solve the above problems.

### BRIEF SUMMARY OF THE INVENTION

In view of this, the main objective of the invention is to provide a prefill valve structure for a refillable spray bottle to overcome the defects in the prior art.

To fulfill the above objective, the invention adopts the following technical solution: a prefill valve structure for a refillable spray bottle comprises a bottle body and a spray nozzle assembly arranged on the bottle body, wherein a partition is arranged at a lower end of an inside of the bottle body and used for dividing the bottle body into an upper cavity and a lower cavity, and a center of the partition is cut through to allow liquid to flow into the bottle body; the prefill valve structure further comprises a tail valve assembly arranged in the lower cavity of the bottle body, the tail valve assembly comprises a tail cover and a piston, the piston is arranged in the tail cover and provided with a filling hole and a vertically through exhaust hole, a filling port corresponding to the filling hole in the piston is formed in the tail cover, an exhaust tube is arranged in the bottle body, a lower end of the exhaust tube is connected to the exhaust hole, and an upper end of the exhaust tube extends into an upper portion of the bottle body; the exhaust hole is sealed and unsealed by an inner surface of the tail cover; or, an exhaust plunger is arranged in the tail cover; when liquid is not injected, the exhaust plunger is connected to the exhaust hole to seal the exhaust hole; when liquid is injected, the exhaust plunger is separated from the exhaust hole to unseal the exhaust hole.

Preferably, a lower portion of the piston is in the shape of a frustum that becomes smaller from top to bottom, a frustum-shaped cavity matching the piston in shape is formed in a bottom of the tail cover, the lower portion of the piston is mounted in the frustum-shaped cavity of the tail cover, and a side face of the lower portion of the piston is in fit and contact with a side face of the frustum-shaped cavity; during liquid filling, a gap is formed between the side face of the lower portion of the piston and the side face of the frustum-shaped cavity when the piston is pushed upwards, and the gap becomes larger when the piston is further pushed upwards.

Preferably, a return spring is arranged between the piston and the partition of the bottle body, the return spring has an end abutting against the piston as well as an end abutting against a lower end surface of the partition, and the return spring always has a downward pushing force to enable a lower end surface of the piston to abut against an inner end surface of the tail cover.

Preferably, the exhaust hole is in the shape of a step that becomes larger from top to bottom, the exhaust plunger is configured as a structure that becomes larger from top to bottom and fits a structure of the exhaust hole, and a sealing structure is formed when the exhaust plunger is inserted into the exhaust hole.

Preferably, an exhaust tube is arranged in the bottle body, and the exhaust tube has an end inserted into the exhaust hole in the piston as well as an end extending upwards to an upper end of the bottle body to discharge air at a top of the bottle body.

Preferably, the filling hole is vertically through and is in the shape of a step that becomes larger from an upper end to a lower end, a connecting frame connected to an inner edge of the partition is arranged at the center of the partition, a first prefill plunger that protrudes downwards and stretches into the filling hole is arranged at a center of the connecting frame, a diameter of the first prefill plunger is less than an inner diameter of the upper end of the filling hole, a stopper ball extending into the filling hole is arranged at a lower end of the first prefill plunger, and a diameter of the stopper ball is greater than the inner diameter of the upper end of the filling hole; in a static state, a rear end of the stopper ball abuts against a step joint of the filling hole to form a sealing state to prevent liquid from leaking; during liquid filling, the piston will be pushed upwards to allow the rear end of the stopper ball to move away from the upper end of the filling hole, such that liquid passes through a gap between the stopper ball and an inner wall of the filling hole.

Preferably, a horizontal liquid inlet connected to the filling hole is formed in a top end of the filling hole and extends to an outer surface of the piston to allow liquid to flow out.

Preferably, at least one annular sealing ring is disposed around the outer surface of the piston and located above and/or below the horizontal liquid inlet; in a static state, an outer end surface of the annular sealing ring abuts against an inner wall of the tail cover to form a sealing state; during liquid filling, the piston will be pushed upwards, the annular sealing ring located above the horizontal liquid inlet will move away from the inner wall of the tail cover, and liquid flows into the lower cavity of the bottle body via the horizontal liquid inlet and then enters the upper cavity.

Preferably, a plunger hole extending upwards from a lower end surface is formed in the piston, and the plunger hole vertically penetrates through the horizontal liquid inlet and is kept away from a top of the piston by a distance.

Preferably, a second prefill plunger extending upwards is arranged on the tail cover and located at a position corresponding to the plunger hole in the piston; in a static state, the second prefill plunger stretches into the plunger hole and penetrates through the horizontal liquid inlet to prevent liquid from leaking; during liquid filling, the piston will be pushed upwards, and the horizontal liquid inlet will move upwards with the piston to be away from the second prefill plunger, such that liquid is injected into the bottle body.

Preferably, the piston is in the shape of a multi-section step, a mounting groove is formed in an upper end surface of the piston, a return spring has an end abutting against the mounting groove of the piston as well as an end abutting against a lower end surface of the partition, a guide pillar allowing the return spring to be disposed therearound and used for positioning the return spring is arranged on the lower end surface of the partition, and the return spring always has a downward pushing force to allow a lower end surface of the piston to abut against an inner end surface of the tail cover to form a sealing state.

Compared with the prior art, the invention has obvious advantages and beneficial effects. specifically, by adopting the above technical solution:

The prefill valve structure provided by the invention is simple, convenient to use and quick to assemble; the tail valve assembly is mounted and fixed to the lower end of the bottle body, and in use, an outlet nozzle of a perfume bottle is inserted into the filling hole at the bottom to inject liquid into the bottle body; the exhaust hole is formed in the piston to discharge air out of the bottle body; various liquid blocking and sealing structures are arranged on the tail valve assembly to effectively prevent liquid in the bottle body from leaking, such that the sealing performance is good. The lower portion of the piston is configured as a frustum structure that becomes smaller from top to bottom, the frustum-shaped cavity is formed in the bottom of the tail cover, the lower portion of the piston is mounted in the frustum-shaped cavity in the bottom of the tail cover, and the side face of the lower portion of the piston is in oblique fit and contact with the side face of the frustum-shaped cavity; during liquid filling, a gap will be formed between the side face of the lower portion of the piston and the side face of the frustum-shaped cavity at the moment the piston is pushed upwards, and gas can circulate via the gap to be discharged of the bottle body, such that more liquid can be injected into the bottle body; compared with a traditional cylindrical piston, the piston can be opened within a shorter distance, such that liquid will not leak in the liquid filling process. In addition, when the piston moves downwards to restore, the frustum-shaped lower portion of the piston will be in tighter fit with the frustum-shaped cavity, and the pressure is high, such that the sealing performance is better.

### BRIEF DESCRIPTION OF THE DRAWINGS

To more clearly explain the technical solutions in the embodiments of the application, drawings used for describing the embodiments of the application or the prior art will be briefly introduced below. Obviously, the drawings in the following description only illustrate some embodiments of the application, and those ordinarily skilled in the art can obtain other drawings according to the following ones without creative labor.

FIG. 1 is an overall structural diagram according to Embodiment 1 of the invention.

FIG. 2 is an exploded structural diagram according to Embodiment 1 of the invention.

FIG. 3 is a complete sectional structural diagram of a bottle body and a tail valve assembly according to Embodiment 1 of the invention.

FIG. 4 is a structural diagram in a filling state according to Embodiment 1 of the invention.

FIG. 5 is an overall structural diagram according to Embodiment 2 of the invention.

FIG. 6 is an exploded structural diagram according to Embodiment 2 of the invention.

FIG. 7 is a complete sectional structural diagram of a bottle body and a tail valve assembly according to Embodiment 2 of the invention.

FIG. 8 is a structural diagram in a filling state according to Embodiment 2 of the invention.

FIG. 9 is an overall structural diagram according to Embodiment 3 of the invention.

FIG. 10 is an exploded structural diagram according to Embodiment 3 of the invention.

FIG. 11 is a complete sectional structural diagram of a bottle body and a tail valve assembly according to Embodiment 3 of the invention.

FIG. 12 is a structural diagram in a filling state according to Embodiment 3 of the invention.

FIG. 13 is a schematic diagram according to another embodiment of the invention.

Wherein, reference signs:

100, bottle body; 110, upper cavity; 120, lower cavity; 130, partition; 140, connecting frame; 150, first prefill plunger; 160, stopper ball; 200, tail valve assembly; 210, tail cover; 211, filling port; 212, exhaust plunger; 213, second prefill plunger; 220, piston; 221, filling hole; 222, exhaust hole; 223, horizontal liquid inlet; 224, plunger hole; 225, annular groove; 230, return spring; 240, exhaust tube; 250, annular sealing ring; 300, spray nozzle assembly; 310, dip tube; 400, outlet nozzle of perfume bottle.

### DETAILED DESCRIPTION OF THE INVENTION

To gain a better understanding of the technical problems to be solved by the application and the technical solutions and beneficial effects of the application, the application is described in further detail below in conjunction with accompanying drawings and embodiments. It should be understood that the specific embodiments described below are merely used for explaining the application rather than limiting the application.

It should be noted that when one element is referred to as being “fixed to” or “arranged on” the other element, it may be located on the other element directly or indirectly. When one element is referred to as being “connected to” the other element, it may be connected to the other element directly or indirectly.

It should be understood that terms such as “length”, “width”, “upper”, “lower”, “front”, “back”, “left”, “right”, “vertical”, “horizontal”, “top”, “bottom”, “inner” and “outer” are used to indicate directional or positional relations based on the accompanying drawings merely for the purpose of facilitating and simplifying the description of the application, do not indicate or imply that devices or elements referred to must be in a specific direction or be configured and operated in a specific direction, and thus should not be construed as limitations of the application.

In addition, terms “first” and “second” are merely used for the purpose of description and should not be construed as indicating or implying relative importance or the number of technical features referred to. Therefore, a feature defined by “first” or “second” may explicitly or implicitly indicate the inclusion of one or more said feature. In the description of the application, “multiple” means two or more, unless otherwise expressly and specifically defined.

To gain a better understanding of the purposes, technical solutions and advantages of the invention, the invention is described in further detail below in conjunction with accompanying drawings and embodiments.

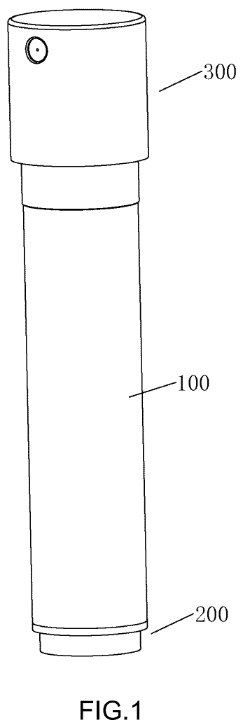

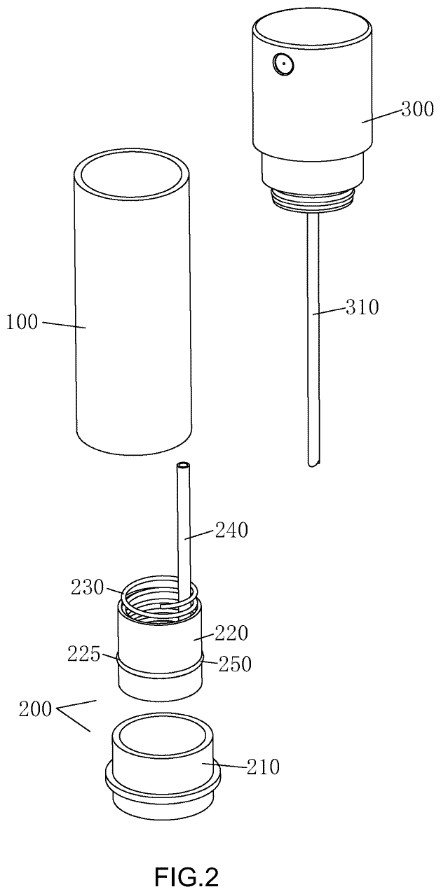

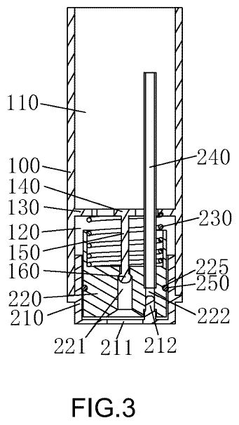

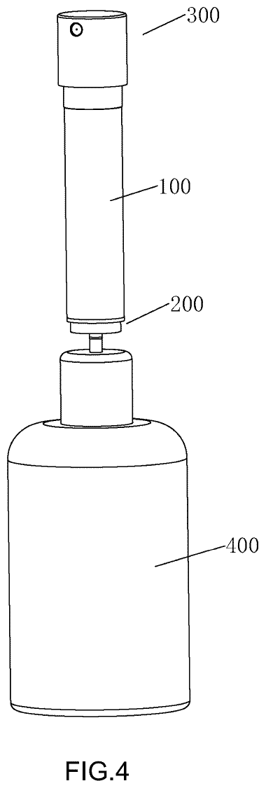

Embodiment 1: Referring to FIGS. 1-4, a prefill valve structure for a refillable spray bottle comprises a bottle body 100 and a spray nozzle assembly 300 arranged on the bottle body 100, wherein the spray nozzle assembly 300 comprises a spray pump (not shown) and a dip tube 310 connected to the spray pump and stretching into the bottle body 100, the spray nozzle assembly 300 is fixedly mounted on the bottle body 100 by snap fit, a partition 130 is arranged at a lower end of the inside of the bottle body 100 and divides the bottle body 100 into an upper cavity 110 and a lower cavity 120, and the center of the partition 130 is cut through to allow liquid to flow into the bottle body 100 from bottom to top. Wherein, the prefill valve structure further comprises a tail valve assembly 200 arranged in the lower cavity 120 of the bottle body 100, the tail valve assembly 200 comprises a tail cover 210 and a piston 220, the piston 220 is arranged in the tail cover 210, and a filling hole 221 and a vertically through exhaust hole 222 are formed in the piston 220, such that liquid can enter the bottle body 100 via the filling hole 221 in the piston 220 and air in the bottle body 100 can be discharged out via the exhaust hole 222, thus improving filling efficiency. A filling port 211 and an exhaust plunger 212 which correspond to the filling hole 221 and the exhaust hole 222 in the piston 220 are arranged on the tail cover 210. During installation, the exhaust plunger 212 stretches into the exhaust hole 222 to prevent liquid in the bottle body from leaking.

In this embodiment, a return spring 230 is arranged between the piston 220 and the partition 130 of the bottle body 100, one end of the return spring 230 abuts against the piston 220, the other end of the return spring 230 abuts against a lower end surface of the partition 130, and the return spring 230 always has a downward pushing force to enable a lower end surface of the piston 220 to abut against an inner end surface of the tail cover 210. In a static state, the return spring 230 pushes the piston 220 to keep the lower end surface of the piston 220 abutting against the inner end surface of the tail cover 210. When an outlet nozzle 400 of a perfume bottle is inserted into the piston 220, the piston 220 will be pushed upwards, and the return spring 230 will contract elastically. After liquid filling is completed, the return spring 230 will restore under the action of an elastic deformation force and push the piston 220 to restore to enable the lower end surface of the piston 220 to abut against the inner end surface of the tail cover 210.

In this embodiment, the exhaust hole 222 is in the shape of a step that becomes larger from top to bottom, and the exhaust plunger 212 is configured as a structure that becomes larger from top to bottom and fits the structure of the exhaust hole 222. In the static state after assembly, the lower end surface of the piston 220 abuts against the inner end surface of the tail cover 210, and the exhaust plunger 212 is inserted into the exhaust hole 222 to prevent liquid in the bottle body 100 from leaking. During liquid filling, the piston 220 will be pushed upwards, and the exhaust hole 222 will move away from the exhaust plunger 212 and compressed air in the bottle body 100 will be discharged via the exhaust hole 222 to allow liquid to enter the bottle body 100, thus improving filling efficiency.

Specifically, an exhaust tube 240 is arranged in the bottle body 100, one end of the exhaust tube 240 is inserted into the exhaust hole 222 in the piston 220, and the other end of the exhaust tube 240 extends upwards to an upper end of the bottle body 100, such that air at the top of the bottle body 100 can be discharged by means of the exhaust tube 240. When liquid is injected into the bottle body 100, compressed air in the bottle will move upwards to be discharged by means of the exhaust tube 240.

In this embodiment, the filling hole 221 is vertically through and is in the shape of a step that becomes larger from an upper end to a lower end, a connecting frame 140 connected to an inner edge of the partition 130 is arranged at the center of the partition 130, a first prefill plunger 150 that protrudes downwards and stretches into the filling hole 221 is arranged at the center of the connecting frame 140, the diameter of the first prefill plunger 150 is less than the inner diameter of the upper end of the filling hole 221, a stopper ball 160 is arranged at a lower end of the first prefill plunger 150, the diameter of the stopper ball 160 is greater than the inner diameter of the upper end of the filling hole 221, and the stopper ball is completely located in the filling hole in the piston. In the static state, a rear end of the stopper ball 160 abuts against a step joint of the filling hole 221 to form a sealing state to prevent liquid from leaking. When liquid is injected into the bottle body 100, the piston 220 will be pushed upwards to allow the stopper ball 160 to move downwards with respect to the piston 220 to be away from the upper end of the filling hole 221, such that a gap is formed between the stopper ball 160 and an inner wall of the filling hole 22 in the piston 220 to allow liquid to enter the bottle body 100.

Further, the stopper ball 160 is not limited to a ball structure and may also be configured as a conical structure, a columnar structure, or the like.

In this embodiment, an annular sealing ring 250 is detachably disposed around an outer surface of the piston 220, an annular groove 225 allowing the annular sealing ring 250 to be mounted therein is formed in the outer surface of the piston 220, and an outer end surface of the annular sealing ring 250 abuts against an inner wall of the tail cover 210 to form a sealing state.

### Embodiment 2

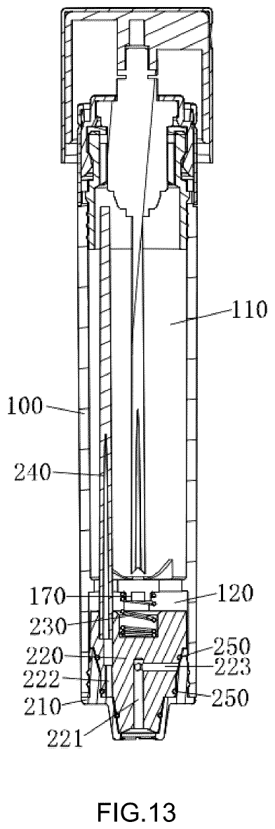

Referring to FIG. 13, this embodiment is different from Embodiment 1 mainly in the shape of the piston 220.

A lower portion of the piston 220 is in the shape of a frustum that becomes smaller from top to bottom, a frustum-shaped cavity matching the piston in shape is formed in the bottom of the tail cover 210, the lower portion of the piston 220 is mounted in the frustum-shaped cavity of the tail cover 210, and a side face of the lower portion of the piston 220 is in fit and contact with a side face of the frustum-shaped cavity. During liquid filling, a gap will be formed between the side face of the lower portion of the piston 220 and the side face of the frustum-shaped cavity when the piston 220 is pushed upwards, and the gap becomes larger when the piston is further pushed upwards. The side face of the piston 220 and the side face of the frustum-shaped cavity of the tail cover 210 are assembled obliquely and are in contact. In this structure, the exhaust plunger may be not arranged, and the exhaust hole 220 in the piston is sealed by means of an end surface arranged in the tail cover 210.

In an initial state, the piston 220 fits the inner end surface of the tail cover 210 to form a sealing state, and the exhaust hole 222 is sealed by the end surface in the tail cover 210. During liquid filling, the piston 220 will be pushed upwards by a perfume bottle; at the moment the piston 220 is pushed upwards, that is, when the piston just leaves the end surface of the tail cover, a gap will be formed between the side face of the piston and the side face of the frustum-shaped cavity of the tail cover, gas in the bottle body is discharged by means of the exhaust tube, the exhaust hole and the gap between the piston and the tail cover, and liquid in the perfume bottle instantly enters the filling hole in the piston, such that the liquid in the perfume bottle is prevented from leaking. In this way, the problem that because a traditional cylindrical piston needs to be pushed upwards by a long distance to discharge gas out of the bottle body to allow liquid in the perfume bottle to enter the bottle body, liquid in the perfume bottle leaks easily in this process is solved. Because the piston is frustum-shaped, the piston just needs to be pushed upwards by a short distance, and a gap is formed between the piston and the tail cover at the moment the piston is pushed upwards, such that gas discharging and liquid filling are performed at the same time, and liquid in the perfume bottle will not be accumulated at the bottle neck.

In addition, because the piston is configured as a frustum structure, when the piston moves downwards to restore, the side face of the bottom of the piston comes in contact with the side face of the frustum-shaped cavity of the tail cover first; when the piston further moves downwards, the piston will be in closer contact with the frustum-shaped cavity of the tail cover, and the contact pressure is increased, such that the sealing performance is better.

The piston 220 is in the shape of a multi-section step, a mounting groove is formed in an upper end surface of the piston 220, one end of the return spring 230 abuts against the mounting groove of the piston 220, the other end of the return spring 230 abuts against the lower end surface of the partition 130, a guide pillar 170 allowing the return spring to be disposed therearound and used for positioning the return spring is arranged on the lower end surface of the partition 130, and the return spring 230 always has a downward pushing force to allow the lower end surface of the piston 220 to abut against the inner end surface of the tail cover 210 to form a sealing state.

In this embodiment, a horizontal liquid inlet 223 may be formed in the piston 220. Liquid enters the bottle body 100 laterally during liquid filling, and gas is discharged laterally.

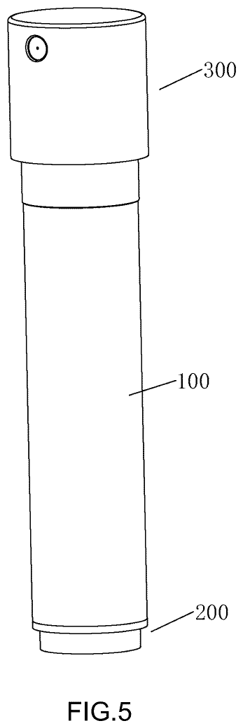

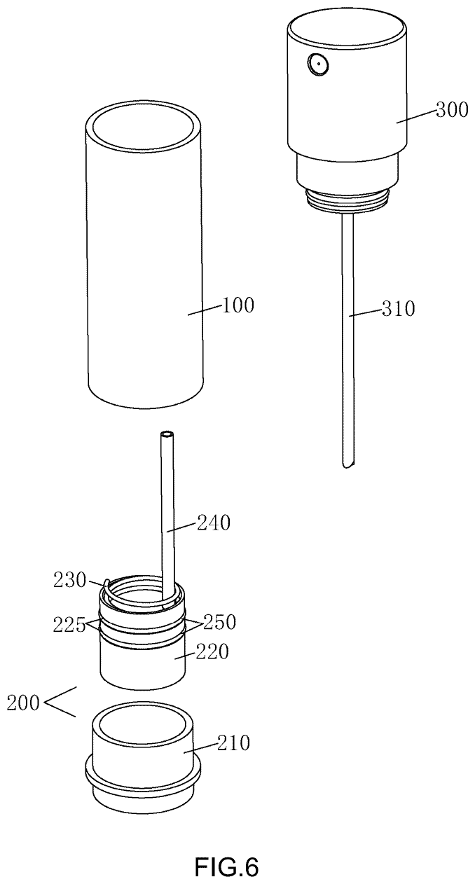

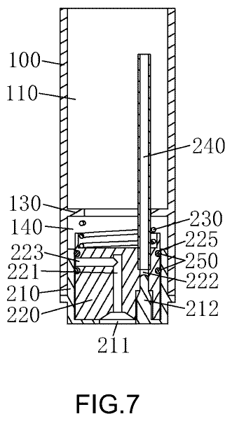

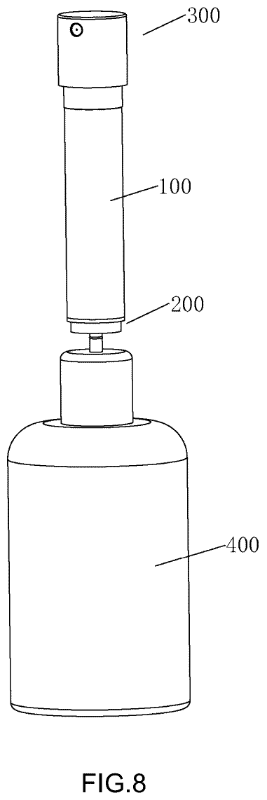

Embodiment 3: Referring to FIGS. 5-8, a prefill valve structure for a refillable spray bottle comprises a bottle body 100 and a spray nozzle assembly 300 arranged on the bottle body 100, wherein the spray nozzle assembly 300 comprises a spray pump (not shown) and a dip tube 310 connected to the spray pump and stretching into the bottle body 100, the spray nozzle assembly 300 is fixedly mounted on the bottle body 100 by snap fit, a partition 130 is arranged at a lower end of the inside of the bottle body 100 and divides the bottle body 100 into an upper cavity 110 and a lower cavity 120, and the center of the partition 130 is cut through to allow liquid to flow into the bottle body 100 from bottom to top. Wherein, the prefill valve structure further comprises a tail valve assembly 200 arranged in the lower cavity 120 of the bottle body 100, the tail valve assembly 200 comprises a tail cover 210 and a piston 220, the piston 220 is arranged in the tail cover 210, and a filling hole 221 and a vertically through exhaust hole 222 are formed in the piston 220, such that liquid can enter the bottle body 100 via the filling hole 221 in the piston 220 and air in the bottle body 100 can be discharged out via the exhaust hole 222, thus improving filling efficiency. A filling port 211 and an exhaust plunger 212 which correspond to the filling hole 221 and the exhaust hole 222 in the piston 220 are arranged on the tail cover 210. During installation, the exhaust plunger 212 stretches into the exhaust hole 222 to prevent liquid in the bottle body from leaking.

In this embodiment, a return spring 230 is arranged between the piston 220 and the partition 130 of the bottle body 100, one end of the return spring 230 abuts against the piston 220, the other end of the return spring 230 abuts against a lower end surface of the partition 130, and the return spring 230 always has a downward pushing force to enable a lower end surface of the piston 220 to abut against an inner end surface of the tail cover 210. In a static state, the return spring 230 pushes the piston 220 to keep the lower end surface of the piston 220 abutting against the inner end surface of the tail cover 210. When an outlet nozzle 400 of a perfume bottle is inserted into the piston 220, the piston 220 will be pushed upwards, and the return spring 230 will contract elastically. After liquid filling is completed, the return spring 230 will restore under the action of an elastic deformation force and push the piston 220 to restore to enable the lower end surface of the piston 220 to abut against the inner end surface of the tail cover 210.

In this embodiment, the exhaust hole 222 is in the shape of a step that becomes larger from top to bottom, and the exhaust plunger 212 is configured as a structure that becomes larger from top to bottom and fits the structure of the exhaust hole 222. In the static state after assembly, the lower end surface of the piston 220 abuts against the inner end surface of the tail cover 210, and the exhaust plunger 212 is inserted into the exhaust hole 222 to prevent liquid in the bottle body 100 from leaking. During liquid filling, the piston 220 will be pushed upwards, and the exhaust hole 222 will move away from the exhaust plunger 212 and compressed air in the bottle body 100 will be discharged via the exhaust hole 222 to allow liquid to enter the bottle body 100, thus improving filling efficiency.

Specifically, an exhaust tube 240 is arranged in the bottle body 100, one end of the exhaust tube 240 is inserted into the exhaust hole 222 in the piston 220, and the other end of the exhaust tube 240 extends upwards to an upper end of the bottle body 100, such that air at the top of the bottle body 100 can be discharged by means of the exhaust tube 240. When liquid is injected into the bottle body 100, compressed air in the bottle will move upwards to be discharged by means of the exhaust tube 240.

In this embodiment, a horizontal liquid inlet 223 connected to the filling hole 221 is formed in a top end of the filling hole 221 and extends to an outer surface of the piston 220 to allow liquid to flow out, and the horizontal liquid inlet 223 is located at an upper end of the tail cover 210. During liquid filling, the piston 220 moves upwards, and the horizontal liquid inlet 223 moves with the piston 220 to be away from the inner wall of the tail cover 210, such that liquid can flow into the bottle body 100.

In this embodiment, annular sealing rings 250 are disposed around the outer surface of the piston 220, the number of annular sealing rings 250 is two, the annular sealing rings 250 are respectively arranged above and below the horizontal liquid inlet 223, and annular grooves 225 allowing the annular sealing rings 250 to be mounted therein are formed in the outer surface of the piston 220, such that outer end surfaces of the annular sealing rings 250 abut against the inner wall of the tail cover to form a sealing state between the piston 220 and the tail cover 210 to prevent liquid from leaking. During liquid filling, the piston 220 will be pushed upwards, the annular sealing ring 250 located above the horizontal liquid inlet 223 will move away from the inner wall of the tail cover 210, the horizontal liquid inlet 223 will move away from the range where it can be closed by the tail cover 210, and liquid injected into the horizontal liquid inlet 223 will flow into the lower cavity 120 of the bottle body 100 and be continuously injected into the upper cavity 110 from bottom to top via the center of the partition 130.

The annular sealing rings are integrally formed on the surface of the piston directly and do not need to be additionally assembled, such that manufacturing and assembly are easy.

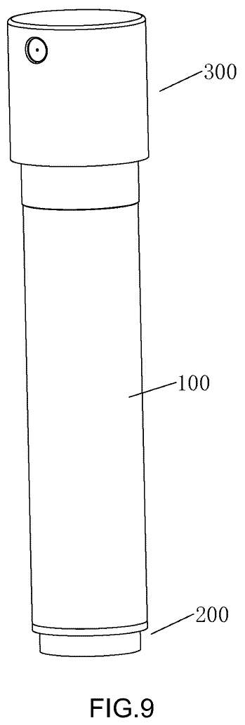

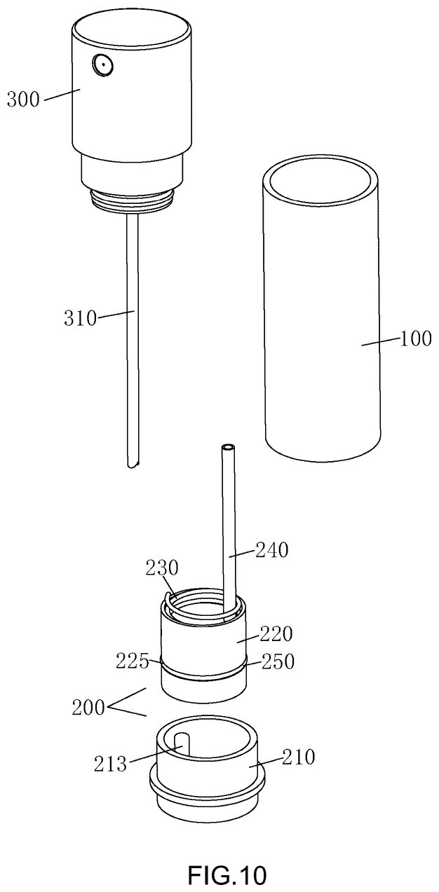

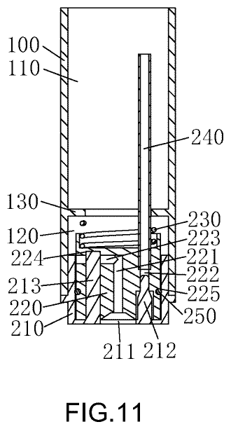

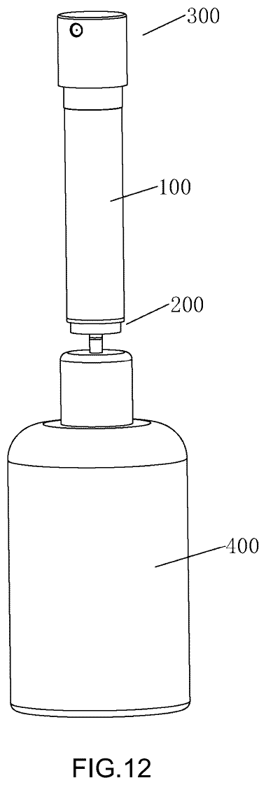

Embodiment 4: Referring to FIGS. 9-12, a prefill valve structure for a refillable spray bottle comprises a bottle body 100 and a spray nozzle assembly 300 arranged on the bottle body 100, wherein the spray nozzle assembly 300 comprises a spray pump (not shown) and a dip tube 310 connected to the spray pump and stretching into the bottle body 100, the spray nozzle assembly 300 is fixedly mounted on the bottle body 100 by snap fit, a partition 130 is arranged at a lower end of the inside of the bottle body 100 and divides the bottle body 100 into an upper cavity 110 and a lower cavity 120, and the center of the partition 130 is cut through to allow liquid to flow into the bottle body 100 from bottom to top. Wherein, the prefill valve structure further comprises a tail valve assembly 200 arranged in the lower cavity 120 of the bottle body 100, the tail valve assembly 200 comprises a tail cover 210 and a piston 220, the piston 220 is arranged in the tail cover 210, and a filling hole 221 and a vertically through exhaust hole 222 are formed in the piston 220, such that liquid can enter the bottle body 100 via the filling hole 221 in the piston 220 and air in the bottle body 100 can be discharged out via the exhaust hole 222, thus improving filling efficiency. A filling port 211 and an exhaust plunger 212 which correspond to the filling hole 221 and the exhaust hole 222 in the piston 220 are arranged on the tail cover 210. During installation, the exhaust plunger 212 stretches into the exhaust hole 222 to prevent liquid in the bottle body from leaking.

In this embodiment, a return spring 230 is arranged between the piston 220 and the partition 130 of the bottle body 100, one end of the return spring 230 abuts against the piston 220, the other end of the return spring 230 abuts against a lower end surface of the partition 130, and the return spring 230 always has a downward pushing force to enable a lower end surface of the piston 220 to abut against an inner end surface of the tail cover 210. In a static state, the return spring 230 pushes the piston 220 to keep the lower end surface of the piston 220 abutting against the inner end surface of the tail cover 210. When an outlet nozzle 400 of a perfume bottle is inserted into the piston 220, the piston 220 will be pushed upwards, and the return spring 230 will contract elastically. After liquid filling is completed, the return spring 230 will restore under the action of an elastic deformation force and push the piston 220 to restore enable the lower end surface of the piston 220 to abut against the inner end surface of the tail cover 210.

In this embodiment, the exhaust hole 222 is in the shape of a step that becomes larger from top to bottom, and the exhaust plunger 212 is configured as a structure that becomes larger from top to bottom and fits the structure of the exhaust hole 222. In the static state after assembly, the lower end surface of the piston 220 abuts against the inner end surface of the tail cover 210, and the exhaust plunger 212 is inserted into the exhaust hole 222 to prevent liquid in the bottle body 100 from leaking. During liquid filling, the piston 220 will be pushed upwards, and the exhaust hole 222 will move away from the exhaust plunger 212 and compressed air in the bottle body 100 will be discharged via the exhaust hole 222 to allow liquid to enter the bottle body 100, thus improving filling efficiency.

Specifically, an exhaust tube 240 is arranged in the bottle body 100, one end of the exhaust tube 240 is inserted into the exhaust hole 222 in the piston 220, and the other end of the exhaust tube 240 extends upwards to an upper end of the bottle body 100, such that air at the top of the bottle body 100 can be discharged by means of the exhaust tube 240. When liquid is injected into the bottle body 100, compressed air in the bottle will move upwards to be discharged by means of the exhaust tube 240.

In this embodiment, a horizontal liquid inlet 223 connected to the filling hole 221 is formed in a top end of the filling hole 221 and extends to an outer surface of the piston 220 to allow liquid to flow out, and the horizontal liquid inlet 223 is located at an upper end of the tail cover 210. During liquid filling, the piston 220 moves upwards, and the horizontal liquid inlet 223 moves with the piston 220 to be away from an inner wall of the tail cover 210, such that liquid can flow into the bottle body 100.

Specifically, a plunger hole 224 extending upwards from the lower end surface is formed in the piston 220, and the plunger hole 224 vertically penetrates through the horizontal liquid inlet 223 and is kept away from the top of the piston 220 by a certain distance, such that liquid will not flow out from here after the plunger hole 224 penetrates through the horizontal liquid inlet 223.

Further, a second prefill plunger 213 extending upwards is arranged on the tail cover 210 and located at a position corresponding to the plunger hole 224 in the piston 220. In the static state, the second prefill plunger 213 stretches into the plunger hole 224 and penetrates through the horizontal liquid inlet 223 to prevent liquid in the bottle body 100 from leaking. During liquid filling, the piston 220 will be pushed upwards, the horizontal liquid inlet 223 will move upwards with the piston 220 to be away from the second prefill plunger 213, at this moment, the second prefill plunger 213 is located below the horizontal liquid inlet 223 and cannot block liquid injected into the horizontal liquid inlet 223, such that the liquid enters the bottle body 100. After liquid filling is completed, the outlet nozzle 400 of the perfume bottle will be extracted from the piston 220, at this moment, the piston 220 will move downwards to restore under the action of a return force from the return spring 230, and the plunger hole 224 will move downwards along the second prefill plunger 213, such that the second prefill plunger 231 vertically penetrates through the horizontal liquid inlet 223 to fulfill a blocking effect to prevent liquid from leaking.

In this embodiment, an annular sealing ring 250 is disposed around the outer surface of the piston 220 and located below the horizontal liquid inlet 223, and an annular groove 225 allowing the annular sealing ring 250 to be mounted therein is formed in the outer surface of the piston 220, such that an outer end surface of the annular sealing ring 250 abuts against the inner wall of the tail cover 210 to form a sealing state between the piston 220 and the tail cover 210 to prevent liquid from leaking. When the piston 220 is pushed upwards, the horizontal liquid inlet 223 will move away from the range where it can be closed by the tail cover 210, and the second prefill plunger 213 will move away from the horizontal liquid inlet 223, such that liquid injected via the horizontal liquid inlet 223 flows into the lower cavity 120 of the bottle body 100 and is continuously injected into the upper cavity 110 from bottom to top via the center of the partition 130.

The above embodiments are merely preferred ones of the invention and provide specific descriptions of the technical principle of the invention, but these descriptions are merely used to explain the principle of the invention and should not be interpreted as limitations of the protection scope of the utility mode in any way. Based on these explanations, any amendments, equivalent substitutions and improvements made based on the spirit and principle of the invention and other specific implementations of the invention that can be figured out by those skilled in the art without creative labor should also fall within the protection scope of the invention.

What is claimed is:

1. A prefill valve structure for a refillable spray bottle, comprising a bottle body and a spray nozzle assembly arranged on the bottle body, a partition being arranged at a lower end of an inside of the bottle body and used for dividing the bottle body into an upper cavity and a lower cavity, a center of the partition being cut through to allow liquid to flow into the bottle body, wherein the prefill valve structure further comprises a tail valve assembly arranged in the lower cavity of the bottle body, the tail valve assembly comprises a tail cover and a piston, the piston is arranged in the tail cover and provided with a filling hole and a vertically through exhaust hole, a filling port corresponding to the filling hole in the piston is formed in the tail cover, an exhaust tube is arranged in the bottle body, a lower end of the exhaust tube is connected to the exhaust hole, and an upper end of the exhaust tube extends into an upper portion of the bottle body;
the exhaust hole is sealed and unsealed by an inner surface of the tail cover; or, an exhaust plunger is arranged in the tail cover; when liquid is not injected, the exhaust plunger is connected to the exhaust hole to seal the exhaust hole; when liquid is injected, the exhaust plunger is separated from the exhaust hole to unseal the exhaust hole.

2. The prefill valve structure for a refillable spray bottle according to claim 1, wherein a lower portion of the piston is in the shape of a frustum that becomes smaller from top to bottom, a frustum-shaped cavity matching the piston in shape is formed in a bottom of the tail cover, the lower portion of the piston is mounted in the frustum-shaped cavity of the tail cover, and a side face of the lower portion of the piston is in fit and contact with a side face of the frustum-shaped cavity; during liquid filling, a gap is formed between the side face of the lower portion of the piston and the side face of the frustum-shaped cavity when the piston is pushed upwards, and the gap becomes larger when the piston is further pushed upwards.

3. The prefill valve structure for a refillable spray bottle according to claim 1, wherein a return spring is arranged between the piston and the partition of the bottle body, the return spring has an end abutting against the piston as well as an end abutting against a lower end surface of the partition, and the return spring always has a downward pushing force to enable a lower end surface of the piston to abut against an inner end surface of the tail cover.

4. The prefill valve structure for a refillable spray bottle according to claim 1, wherein the exhaust hole is in the shape of a step that becomes larger from top to bottom, the exhaust plunger is configured as a structure that becomes larger from top to bottom and fits a structure of the exhaust hole, and a sealing structure is formed when the exhaust plunger is inserted into the exhaust hole.

5. The prefill valve structure for a refillable spray bottle according to claim 1, wherein the filling hole is vertically through and is in the shape of a step that becomes larger from an upper end to a lower end, a connecting frame connected to an inner edge of the partition is arranged at the center of the partition, a first prefill plunger that protrudes downwards and stretches into the filling hole is arranged at a center of the connecting frame, a diameter of the first prefill plunger is less than an inner diameter of the upper end of the filling hole, a stopper ball extending into the filling hole is arranged at a lower end of the first prefill plunger, and a diameter of the stopper ball is greater than the inner diameter of the upper end of the filling hole; in a static state, a rear end of the stopper ball abuts against a step joint of the filling hole to form a sealing state to prevent liquid from leaking; during liquid filling, the piston will be pushed upwards to allow the rear end of the stopper ball to move away from the upper end of the filling hole, such that liquid passes through a gap between the stopper ball and an inner wall of the filling hole.

6. The prefill valve structure for a refillable spray bottle according to claim 1, wherein a horizontal liquid inlet connected to the filling hole is formed in a top end of the filling hole and extends to an outer surface of the piston to allow liquid to flow out.

7. The prefill valve structure for a refillable spray bottle according to claim 6, wherein at least one annular sealing ring is disposed around the outer surface of the piston and located above and/or below the horizontal liquid inlet; in a static state, an outer end surface of the annular sealing ring abuts against an inner wall of the tail cover to form a sealing state; during liquid filling, the piston will be pushed upwards, the annular sealing ring located above the horizontal liquid inlet will move away from the inner wall of the tail cover, and liquid flows into the lower cavity of the bottle body via the horizontal liquid inlet and then enters the upper cavity.

8. The prefill valve structure for a refillable spray bottle according to claim 6, wherein a plunger hole extending upwards from a lower end surface is formed in the piston, and the plunger hole vertically penetrates through the horizontal liquid inlet and is kept away from a top of the piston by a distance.

9. The prefill valve structure for a refillable spray bottle according to claim 8, wherein a second prefill plunger extending upwards is arranged on the tail cover and located at a position corresponding to the plunger hole in the piston; in a static state, the second prefill plunger stretches into the plunger hole and penetrates through the horizontal liquid inlet to prevent liquid from leaking; during liquid filling, the piston will be pushed upwards, and the horizontal liquid inlet will move upwards with the piston to be away from the second prefill plunger, such that liquid is injected into the bottle body.

10. The prefill valve structure for a refillable spray bottle according to claim 7, wherein the piston is in the shape of a multi-section step, a mounting groove is formed in an upper end surface of the piston, a return spring has an end abutting against the mounting groove of the piston as well as an end abutting against a lower end surface of the partition, a guide pillar allowing the return spring to be disposed therearound and used for positioning the return spring is arranged on the lower end surface of the partition, and the return spring always has a downward pushing force to allow a lower end surface of the piston to abut against an inner end surface of the tail cover to form a sealing state.
